(19) United States
(12) Patent Application Publication
(10) Pub. No.: US 2010/0171012 A1
(43) Pub. Date: Jul. 8, 2010

(54) FURNITURE PROVIDED WITH LENGTH-ADJUSTABLE LEGS

(76) Inventor: Chuen-Jong TSENG, Chiayi Hsien (TW)

Correspondence Address: LADAS & PARRY LLP, 224 SOUTH MICHIGAN AVENUE, SUITE 1600, CHICAGO, IL, 60604, US

(21) Appl. No.: 12/348,359

(22) Filed: Jan. 5, 2009

(51) Int. Cl. F16M 11/24; A47B 91/02

(52) U.S. Cl. 248/188.2; 248/188.8

(57) ABSTRACT

A piece of furniture includes a plurality of leg units and an upper furniture part. Each of the leg units includes a vertically extending outer tube having a plurality of positioning holes, an inner tube extending slidably into the outer tube and having a through hole, and a positioning component connected to the inner tube for positioning the inner tube at a selected extended state relative to the outer tube. The upper furniture part is connected to the leg units. The inner and outer tubes are vertically movable relative to each other so as to align the through hole with a selected one of the positioning holes. The positioning component includes a spring part disposed in the inner tube, and a limiting part connected to the spring part and projecting removably into the through hole and the selected one of the positioning holes.

### BACKGROUND OF THE INVENTION

1. Field of the Invention

The present invention relates to a piece of furniture, more particularly to a piece of furniture provided with length-adjustable legs.

2. Description of the Related Art

Depending on their use, chairs can be classified into office chairs, stools for a dining table, bar stools, leisure chairs, etc. A seat height of the office chair is usually adjustable by manipulating a control pole for controlling a pressure device disposed in the office chair. However, heights of the conventional stools and leisure chairs are usually un-adjustable, such that the conventional stools and leisure chairs cannot conform with a physical size and a desired sitting posture of a user. Therefore, a mechanism to adjust legs of a chair for adjusting a seat height of the chair has been proposed heretofore.

Referring to FIGS. 1 and 2, U.S. Pat. No. 7,278,687 discloses a chair 1 including a seat 11, a backrest 12, and four leg units 13. Each of the leg units 13 includes a leg 131, a leg extender 132 screwed removably to a bottom of the leg 131, and an end cap 133 screwed optionally to the leg 131 or to the leg extender 132. The leg extenders 132 are optionally attached to the bottoms of the legs 131 so as to adjust the lengths of the leg units 13, such that the seat height of the chair 1 can be adjusted. The end caps 133 are attached to the leg extenders 132 when the leg extenders 132 are in use, and are attached to the legs 131 when the leg extenders 132 are not in use.

Although the leg extenders 132 can be used for adjusting the lengths of the leg units 13, it takes a relatively long time to assemble and disassemble the same due to engagement by screwing. In particular, when a user wants to shorten the lengths of the leg units 13, the user needs to disassemble the leg extenders 132 and the end caps 133 and then to screw the end caps 133 to the bottoms of the legs 131. This complex process for adjustment causes inconvenience and is time consuming. Thus, the aforementioned leg units 13 still have room for improvement. Moreover, other pieces of furniture (such as a table) are usually not provided with length-adjustable legs.

### SUMMARY OF THE INVENTION

Therefore, an object of the present invention is to provide a piece of furniture provided with length-adjustable legs that are adjusted easily and conveniently.

The piece of furniture of this invention comprises a plurality of leg units and an upper furniture part. Each of the leg units includes a vertically extending outer tube, an inner tube extending slidably into the outer tube, and a positioning component connected to the inner tube. The upper furniture part is connected to one end of one of the inner and outer tubes of each of the leg units.

The outer tube includes an outer tube wall that has opposite inner and outer wall surfaces, and that has a plurality of positioning holes formed through the inner and outer wall surfaces of the outer tube wall and vertically spaced apart from each other. The inner tube includes an inner tube wall that has opposite inner and outer tube surfaces and that has a through hole formed through the inner and outer tube surfaces of the inner tube wall. The inner and outer tubes are vertically movable relative to each other so as to align the through hole with a selected one of said positioning holes. The positioning component includes a spring part disposed in the inner tube, and a limiting part connected to the spring part and biased by the spring part to project removably into the through hole and the selected one of the positioning holes for positioning the inner tube at a selected extended state relative to the outer tube.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional chair;

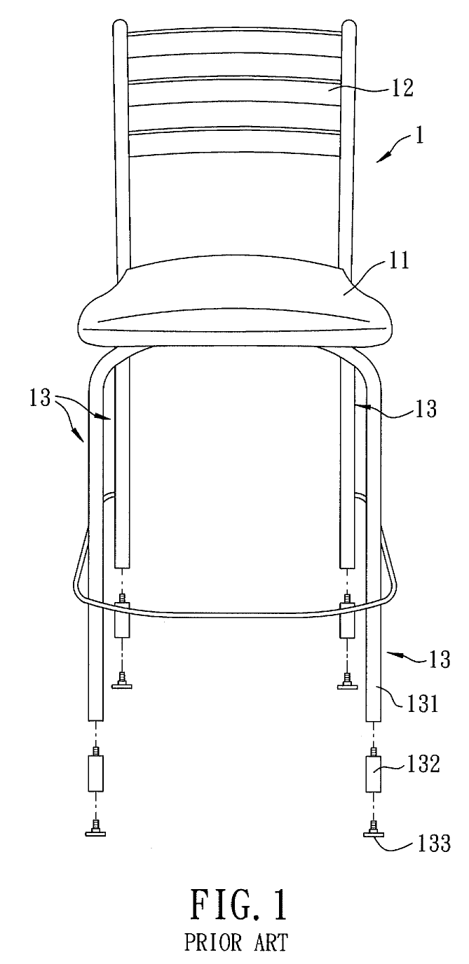

FIG. 2 is an exploded fragmentary perspective view of a leg unit of the conventional chair;

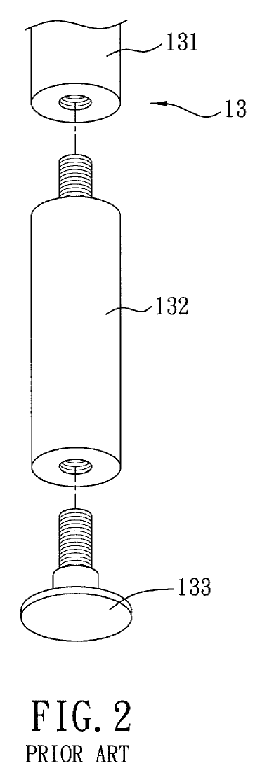

FIG. 3 is a perspective view of a preferred embodiment of a piece of furniture provided with length-adjustable legs according to this invention;

FIG. 4 is a partly sectional view of the preferred embodiment, and shows a leg unit of the preferred embodiment in a shortest state;

FIG. 5 is a partly sectional view similar to FIG. 4, and shows that a limiting part of a positioning component has disengaged an outer tube and that an inner tube has been moved downwardly from the state of FIG. 4; and

FIG. 6 is a partly sectional view similar to FIG. 4, and shows one of the leg units of the preferred embodiment in a relatively longer state.

### DETAILED DESCRIPTION OF THE PREFERRED EMBODIMENT

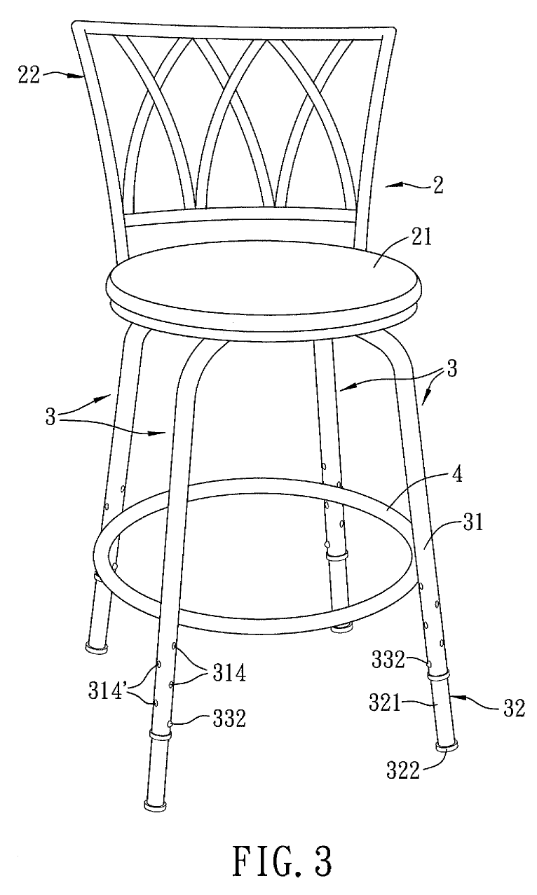

Referring to FIGS. 3 to 5, the preferred embodiment of a piece of furniture provided with length-adjustable legs according to the present invention is shown to be embodied in a chair. However, the length-adjustable legs according to the present invention are also adapted for a table and other pieces of furniture in practice.

Accordingly, the piece of furniture of this embodiment includes an upper furniture part 2, four leg units 3 connected to the upper furniture part 2 and spaced apart from each other, and a circular frame 4 connected to the leg units 3.

The upper furniture part 2 includes a seat 21 and a backrest 22 extending upwardly from a rear edge of the seat 21. Each of the leg units 3 includes a vertically extending outer tube 31, an inner tube 32 extending slidably into the outer tube 31, and a positioning component 33 connected to the inner tube 32 for positioning the inner tube 32 at a selected extended state relative to the outer tube 31. The seat 21 of the upper furniture part 2 is connected to one end of the outer tubes 31 of the leg units 3 in the preferred embodiment. The circular frame 4 is connected to the outer tubes 31 of the leg units 3 for enhancing stability of the leg units 3.

The outer tube 31 includes an outer tube wall 311 that has an inner wall surface 312 and an opposite outer wall surface 313. In the preferred embodiment, the outer tube wall 311 has five positioning holes that are formed through the inner and outer wall surfaces 312, 313 thereof and that are vertically spaced apart from each other. Three of the five positioning holes define a first set 314 of vertically aligned positioning holes, and the other two define a second set 314′ of vertically aligned positioning holes that is angularly spaced apart from the first set 314 of vertically aligned positioning holes. Preferably, an upper positioning hole of the second set 314′ is disposed at a vertical position between vertical positions of upper and middle positioning holes of the first set 314, and a lower positioning hole of the second set 314′ is disposed at a vertical position between vertical positions of middle and lower positioning holes of the first set 314.

The inner tube 32 includes an inner tube wall 321 and a base 322 disposed at a bottom edge of the inner tube wall 321. The inner tube wall 321 has an inner tube surface 323, an opposite outer tube surface 324, and a through hole 325 formed through the inner and outer tube surfaces 323, 324 thereof. A diameter of the base 322 is slightly larger than an external diameter of the outer tube 31 so as to be able to abut against a bottom edge of the outer tube wall 311. Moreover, the inner tube 32 is vertically movable relative to the outer tube 31 and is rotatable relative to the outer tube 31 about a vertical axis so as to align the through hole 325 with a selected positioning hole of the first or second set 314, 314′.

The positioning component 33 includes a spring part 331 disposed in the inner tube 32, and a limiting part 332 connected to the spring part 331 and biased by the spring part 331 to project removably into the through hole 325 and the selected positioning hole of the first or second sets 314, 314′ The spring part 331 is formed from a resilient metal wire or plate, and is adapted for providing a radial biasing force to the limiting part 332. The spring part 331 is substantially V-shaped, and includes an elongate connecting section 333 connected to the inner tube surface 323 of the inner tube wall 321, and an elongate spring section 334 extending obliquely from the connecting section 333. The spring section 334 is not connected to the inner tube surface 323 of the inner tube wall 321. The limiting part 332 has a curved profile, and is connected to one end of the spring section 334 distal from the connecting section 333 and corresponding to a position of the through hole 325.

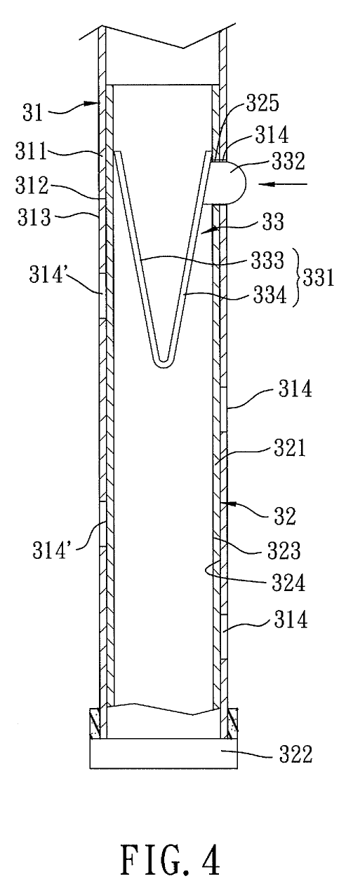

Lengths of the leg units 3 can be adjusted during use. When the leg units 3 are in a shortest state as shown in FIG. 4, the inner tube wall 321 extends completely into the outer tube 31, and the base 322 of the inner tube 32 abuts against the bottom edge of the outer tube wall 311. The limiting part 332 of the positioning component 33 projects into the through hole 325 and the upper positioning hole of the first set 314 for positioning the inner tube 32 relative to the outer tube 31.

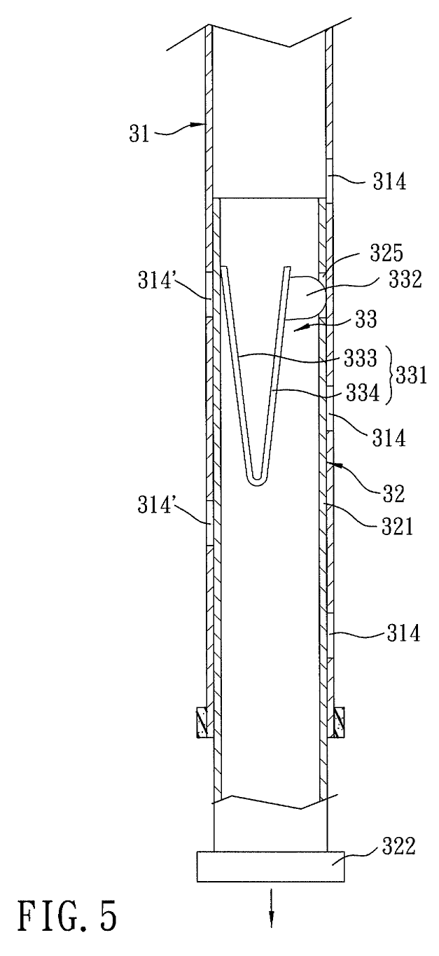

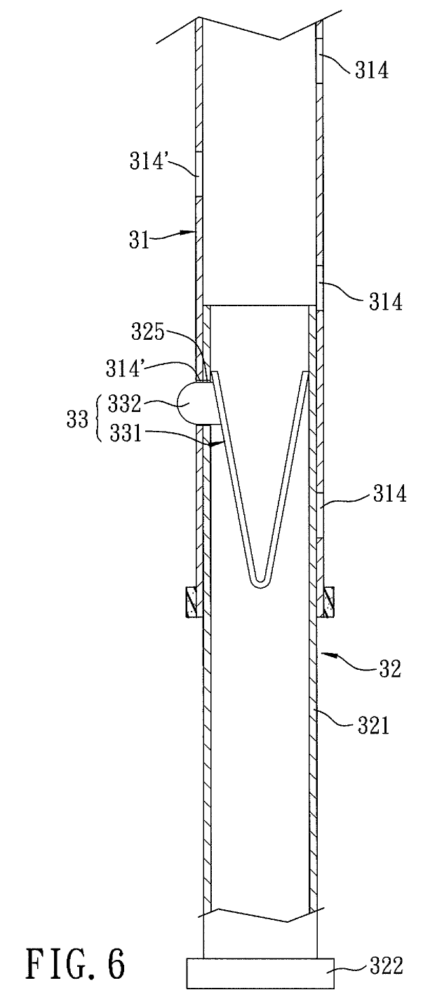

Referring to FIGS. 4 to 6, when it is intended to adjust the lengths of the leg units 3, the limiting part F 332 of the positioning component 33 of each leg unit 3 is pressed in a direction indicated by an arrow in FIG. 4. The limiting part 332 moves inwardly into the inner tube 32, and disengages the originally selected positioning hole of the first or second set 314, 314′ as shown in FIG. 5, such that the inner tube 32 is movable relative to the outer tube 31 under this condition. Because the spring part 331 is connected to the limiting part 332, the spring part 331 deforms and stores energy attributed to inward movement of the limiting part 332. Subsequently, the user needs to move the inner tube 32 to a desired extended state relative to the outer tube 31, and the positioning component 33 moves with the inner tube 32. When the limiting part 332 is registered with a desired positioning hole of the first or second set 314, 314′, the limiting part 332 projects into the desired positioning hole of the first or second set 314, 314′ automatically, due to release of the energy stored in the spring part 331 which results in a radial biasing force provided to the limiting part 332. The inner tube 32 is positioned at the desired extended state relative to the outer tube 31 at this time.

It should be noted that the outer tube 31 of each leg unit 3 has five positioning holes at different heights in the preferred embodiment, such that the lengths of the leg units 3 can be adjusted to any of five lengths. Moreover, because the first set 314 of vertically aligned positioning holes and the second set 314′ of vertically aligned positioning holes are angularly spaced apart from each other, it is needed to rotate the inner tube 32 relative to the outer tube 31 for registering the limiting part 332 with the desired positioning hole when the desired positioning hole and the originally selected positioning hole belong to different ones of the first and second sets 314, 314′.

Furthermore, the grouping of the positioning holes in the first and second sets 314, 314′ can minimize an adverse effect on the structural strength of the outer tube 31. If all of the positioning holes are aligned in one vertical line, stress can concentrate on one side of the outer tube 31 where the positioning holes are disposed at, such that the structural strength of the outer tube 31 is relatively weaker. Therefore, the configuration of the first and second sets 314, 314′ is preferred for adjusting the leg units 3 to various lengths and for maintaining the structural strength of the outer tube 31. Moreover, the base 322 of the inner tube 32 is configured to abut against the bottom of the outer tube wall 311 of the outer tube 31, such that the inner tube 32 is stopped from moving further into the outer tube 31 when the leg units 3 are in the shortest state as shown in FIG. 4.

It is apparent from the above that the inner tube 32 is vertically movable relative to the outer tube 31, and the positioning component 33 is used for positioning the inner tube 32 at the desired extended state relative to the outer tube 31. Because of the radial biasing force provided by the spring part 331 of the positioning component 33, the limiting part 332 of the positioning component 33 automatically projects into the through hole 325 and the corresponding one of the positioning holes for positioning the inner tube 32 at the desired extended state relative to the outer tube 31. When the user wants to adjust the lengths of the leg units 3, the user just needs to press the limiting part 332 of the positioning component 33 of each leg unit 3 and to pull/push the inner tube 32 to the desired extended state. The limiting part 332 will then automatically project into the through hole 325 and the corresponding one of the positioning holes due to the radial biasing force provided by the spring part 331. Therefore, the piece of furniture of the preferred embodiment according to the present invention has advantages of convenient and quick adjustment in the lengths of the leg units, and ease of use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A piece of furniture comprising:
a plurality of leg units, each of which includes
a vertically extending outer tube including an outer tube wall that has opposite inner and outer wall surfaces, said outer tube wall having a plurality of positioning holes that are formed through said inner and outer wall surfaces of said outer tube wall and that are vertically spaced apart from each other,
an inner tube including an inner tube wall that has opposite inner and outer tube surfaces and that has a through hole formed through said inner and outer tube surfaces of said inner tube wall, said inner tube extending slidably into said outer tube, said inner and outer tubes being vertically movable relative to each other so as to align said through hole with a selected one of said positioning holes, and
a positioning component including a spring part disposed in said inner tube, and a limiting part connected to said spring part and biased by said spring part to project removably into said through hole and the selected one of said positioning holes for positioning said inner tube at a selected extended state relative to said outer tube; and
an upper furniture part connected to one end of one of said inner and outer tubes of said leg units,
wherein, for each of said leg units, said outer and inner tubes are rotatable relative to each other about a vertical axis, and said positioning holes include a first set of vertically aligned positioning holes and a second set of vertically aligned positioning holes that is angularly spaced apart from said first set of vertically aligned positioning holes.

2. The piece of furniture as claimed in claim 1, wherein said spring part of said positioning component provides a radial biasing force to said limiting part, and includes an elongate connecting section having one end connected to said inner tube surface of said inner tube wall, and an elongate spring section extending obliquely from said connecting section and having one end distal from said connecting section and connected to said limiting part.

3. (canceled)

4. The piece of furniture as claimed in claim 1, wherein each of said positioning holes in said second set is disposed between a corresponding adjacent pair of said positioning holes in said first set.

5. The piece of furniture as claimed in claim 1, wherein said upper furniture part is connected to said outer tubes of said leg units, and
wherein, for each of said leg units, said outer tube wall of said outer tube has a bottom edge, said inner tube wall of said inner tube has a bottom edge, and said inner tube further includes a base disposed at said bottom edge of said inner tube wall and configured to abut against said bottom edge of said outer tube wall.

6. The piece of furniture as claimed in claim 1, wherein said upper furniture part is a seating part connected to said outer tubes of said leg units.
